(19) United States
(12) Patent Application Publication
(10) Pub. No.: US 2025/0298819 A1
(43) Pub. Date: Sep. 25, 2025

(54) Automatically Sectioning of Construction Specification Documents for Query Optimization

(71) Applicant: Autodesk, Inc., San Francisco, CA (US)

(72) Inventors: Mo Han, Boston, MA (US); Varadarajulu Pyda, Ashburn, VA (US); Sanjay Penumetsa Raju, San Francisco, CA (US); Alexander Huang, Fremont, CA (US); Vikas Sakaray, Bengaluru (IN); Prateek Agarwal, Bengaluru (IN); Patricia Keaney, Greenbrae, CA (US); Graham Michael Garland, San Francisco, CA (US); Beatriz Chinelato Guerra, San Antonio, TX (US); Gopi Krishna Nuti, Bengaluru (IN); Surendran Subbiah, Garden City, KS (US); Atul Avinash Shelke, Vienna, VA (US)

(73) Assignee: Autodesk, Inc., San Francisco, CA (US)

(21) Appl. No.: 19/084,117

(22) Filed: Mar. 19, 2025

Related U.S. Application Data
(60) Provisional application No. 63/567,378, filed on Mar. 19, 2024.

(51) Int. Cl. G06F 16/3332; G06F 16/31; G06F 16/334; G06F 16/335; G06F 16/338; G06F 16/353

(52) U.S. Cl. CPC G06F 16/3334; G06F 16/31; G06F 16/3347; G06F 16/335; G06F 16/338; G06F 16/353

(57) ABSTRACT

A method and system process a construction domain query. A user query relating to a construction specification document is obtained. The construction specification document is obtained A Table of Content (ToC) page detection module autonomously classifies each page of the construction specification document as a table of content (ToC) or not. A text extraction module autonomously extracts text content from the construction specification document. A document sectioning module autonomously outputs section titles based on the ToC page classification results and the extracted text content, and sections the construction specification document into sections based on the section titles. The user query is processed based on the sectioned construction specification document.

### CROSS-REFERENCE TO RELATED APPLICATIONS

This application claims the benefit under 35 U.S.C. Section 119 (e) of the following co-pending and commonly-assigned U.S. provisional patent application(s), which is/are incorporated by reference herein:

Provisional Application Ser. No. 63/567,378, filed on Mar. 19, 2024, with inventor(s) Mo Han, Varadarajulu Pyda, Sanjay Penumetsa Raju, Alexander Huang, Vikas Sakaray, Prateek Agarwal, Patricia Keaney, Graham Michael Garland, Beatriz Chinelato Guerra, Gopi Krishna Nuti, Surendran Subbiah, and Atul Avinash Shelke entitled “Systems and Methods for Automatically Sectioning the Construction Specification Documents and Using the Information to Answer Simple to Complex Questions,” attorneys' docket number 30566.0623USP1.

This application is related to the following co-pending and commonly-assigned patent application(s) which is/are incorporated by reference herein:

U.S. patent application Ser. No. 18/946,571, filed on Nov. 13, 2024, by Surendran Subbiah, Mo Han, Vikas Sakaray, Varadarajulu Pyda, Patricia Keaney, Graham Michael Garland, Beatriz Chinelato Guerra, and Gopi Krishna Nuti, entitled “Generative Artificial Intelligence (AI) Construction Specification Interface,” attorneys' docket number 30566.0619USU1, which application claims the benefit under 35 USC Section 119 (e) of the following co-pending and commonly-assigned US Provisional patent application which is incorporated by reference herein: Provisional Application Ser. No. 63/598,341, filed on Nov. 13, 2023, with inventor(s) Surendran Subbiah, Mo Han, Theerath Geddada, Varadarajulu Pyda, Patricia Keaney, Graham Michael Garland, Beatriz Chinelato Guerra, and Gopi Krishna Nuti entitled “Generative Artificial Intelligence (AI) Specification Interface,” attorneys' docket number 30566.0619USP1.

### BACKGROUND OF THE INVENTION

### 1. Field of the Invention

The present invention relates generally to construction specifications, and in particular, to a method, apparatus, system, and article of manufacture for analyzing and sectioning a construction specification to optimize queries of the construction specification.

### 2. Description of the Related Art

Users often need to refer to information mentioned in large specifications documents. Manually searching for this information is very unwieldy, time consuming and error prone. There exists the need for a system which can automatically read and understand the large and complex specifications documents and retrieve the specific information user is looking for. Prior art systems fail to provide a mechanism to automate this information retrieval. To better understand the problems of the prior art, a description of prior art approaches may be useful.

Work/construction specifications are documents that cover detailed information on projects. They are often extremely long and detailed, making them difficult to parse, use and obtain meaningful information. Searches are often long and labor intensive. For example, if the construction specification document is 1000 pages and a user needs information on a particular faucet flow rate, it's likely going to take quite a bit of time to gather. There exists a need for a faster, more efficient way of obtaining information.

In view of the above, it may be noted that construction data is used in various parts of the construction project lifecycle. Such construction data includes design data, planning data, project management data, etc. All data may be available in a single platform, but project teams doing day-to-day tasks are required to retrieve information (in real time) from different locations where the relevant data for that team is siloed. For example, various project teams may encounter issues happening in the field or with the design such as requests for information (RFIs) being received/logged into a system, schedules with upcoming activities, assets being installed, forms/checklists filled out by contractors, etc. In this regard, a contractor may need to determine open issues such as which RFIs need to be addressed before a crew arrives on a jobsite or whether specific information required for an RFI has been entered in the project/construction specification. In other words, relevant information for different aspects of a project is siloed within a construction system platform. What is needed is the capability to quickly and efficiently access the relevant information regardless of how/where it is siloed/stored within a construction system platform.

In an exemplary use case, it may be desirable to extract/determine a list of products and materials that need to be procured from a construction specification. Such products/materials may be required to go through an approval process first. The mechanism for managing the approvals is called “submittals”. As part of the submittal process, an architect may specify that a general contractor (GC) needs to source/purchase a particular product (e.g., an HVAC system) that meets certain requirements as set forth in the construction specification. The GC may then have to read through the construction specification manually page by page to determine the requirements and identify a particular product that the GC then requests permission to install (e.g., from the architect or project supervisor). It is desirable to extract the necessary information from the construction specification that is necessary for such submittals without having to manually parse the specification.

In view of the above, what is needed is the ability to easily and efficiently extract information from a construction specification.

### SUMMARY OF THE INVENTION

Embodiments of the invention autosection a construction specification into smaller, logically correct segments based on metadata at a specification level. Further, depending on the complexity of the query of the construction specification, novel workflows to augment the search may be employed. One or more embodiments filter away irrelevant specification sections using deep learning models. Further, deep learning models may be used to generate the query answer from all relevant specification sections thereby greatly improving accuracy.

### BRIEF DESCRIPTION OF THE DRAWINGS

Referring now to the drawings in which like reference numbers represent corresponding parts throughout:

FIG. 1 illustrates the specification workflow utilized in accordance with one or more embodiments of the invention;

FIG. 2 illustrates an overview of the architecture for providing generative artificial intelligence (AI) information in accordance with one or more embodiments of the invention;

FIG. 3 illustrates an overview of the components and architectural workflow/data processing for auto-sectioning and utilizing a sectioned construction specification in accordance with one or more embodiments of the invention;

FIG. 4 illustrates further details for the integration of the auto-sectioning AI with a specification tool in accordance with one or more embodiments of the invention;

FIG. 5 illustrates an alternative view of an architecture for the automated sectioning in accordance with one or more embodiments of the invention;

FIG. 6 illustrates the specification tool workflow that utilizes the architecture of FIG. 5 in accordance with one or more embodiments of the invention;

FIG. 7 illustrates details of the sectioning service that may be utilized to perform autosectioning in accordance with one or more embodiments of the invention;

FIG. 8 illustrates further details of the ToC page detection module in accordance with one or more embodiments of the invention;

FIG. 9 illustrates further details of the text extraction module in accordance with one or more embodiments of the invention;

FIG. 10 illustrates the further details of the document sectioning module in accordance with one or more embodiments of the invention;

FIG. 11 illustrates the overall methodology used for extracting insights from construction specifications using generative AI in accordance with one or more embodiments of the invention;

FIG. 12 illustrates the details for creating an index in accordance with one or more embodiments of the invention;

FIG. 13 illustrates the details for generating vector embeddings in accordance with one or more embodiments of the invention;

FIG. 14 illustrates the overall flow for the router/router model in accordance with one or more embodiments of the invention;

FIG. 15 illustrates the details for a simple flow in accordance with embodiments of the invention;

FIG. 16 illustrates the details for a complex flow in accordance with one or more embodiments of the invention;

FIG. 17 illustrates the details for context retrieval in accordance with one or more embodiments of the invention;

FIGS. 18A and 18B are control flow diagrams for auto-sectioning and performing a search query in accordance with one or more embodiments of the invention;

FIG. 19 is an exemplary hardware and software environment used to implement one or more embodiments of the invention; and

FIG. 20 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Project Specification Overview

As described above, project/construction specifications are used in all phases of construction (from planning to procurement to construction) and consist of/comprise a companion contractual document to construction drawings. They are used to create submittal logs and are also referenced during building and for negotiating change orders with added scope or modified schedules. Specifications exist alongside plans as critical documents to help project teams execute effectively. Customers need one integrated platform that provides easy access and navigation to all critical project information including planned and the critical information buried in the specification

Further project specifications outline project requirements and standards for construction. Construction specifications are often generated by the design team and transmitted/delivered to the construction team (e.g., the general contractor) as a very large PDF text-based document that can be hundreds or thousands of pages long. Thereafter, the project specification is referenced continually throughout the project lifecycle. However, the project specification may require sectioning for scope and subcontractors. It may also be noted that different personas may utilize the specification at different points in a project. Personas may include general contractors, project managers, site superintendents, subcontractors, owner's representatives, cost estimators, commissioning agents, the overall design team (e.g., project architects and engineers), etc. It can be difficult (if not impossible) to find relevant information from 100-1000 (s) page document. Further, it is not unusual for specification documents to include 300-500 sections. Users typically want to locate information in a specific section.

To make it possible to navigate specifications by section and to find specific information in relevant sections, specification tools must allow the user to create sections for the specification. However, manually creating 500 sections would be extremely time consuming. Accordingly, embodiments of the invention automate specification sectioning so that the power of sections is available without the time-consuming need to manually create sections. To demonstrate the benefit of auto-sectioning of embodiments of the invention, a description of high-level user stories may be useful.

An exemplary persona that may utilize embodiments of the invention is that of a project manager. Managers are typically office-based team members who will manage and deploy specification-based information, working in both web and mobile environments. A construction project manager may desire to upload a specification into an application while having specification sections automatically created so that they don't have to do time-consuming, manual work to make it easy to find information in very large specs. Auto-sectioning impacts the following activities of a manager: uploading a spec document (and automatically generating spec sections); viewing/navigating a spec document (navigation is typically done to the section level); searching/filtering a spec document; exporting the full document or sections of the document; and reviewing, adding, deleting, renaming, or editing specification sections.

A second exemplary persona is that of a project member that typically consists of consumers/field-based team members who need to reference specification information, usually on a mobile device. Construction team members desire to quickly find the specific information relevant to what they need to know, and to be able to search or navigate to the right information fast. Consumer personas (via embodiments of the invention) will be able to view specifications, navigate spec sections, and search/filter a spec document.

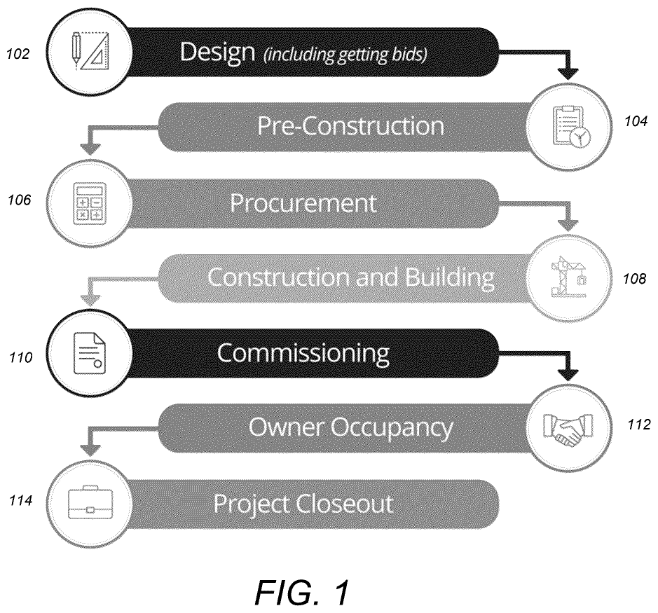

FIG. 1 illustrates the specification workflow utilized in accordance with one or more embodiments of the invention. As illustrated, at 102, the design is generated (including getting bids). The design includes the overall design, materials, and installation requirements. At step 104, during pre-construction, cost estimates and bidding documentation are prepared. At step 106, during the procurement phase, submittal and procurement logs are created. At step 108, during the construction and building phase, the assets needed for the project are managed. During step 110, any needed items are commissioned including preparing project management documentation (RFIs, submittals, etc.). The turnover package requirements are then outlined (i.e., owner occupancy requirements) at step 112 and the project is closed out at step 114.

In one or more embodiments of the invention, a specifications tool may be utilized to provide critical, up-to-date specification information to all team members spanning the project lifecycle. Site and field-based team members can easily access project specs in conjunction with their plans and models in a single ecosystem. In other words, such a tool provides the ability to find relevant data from project specifications for easier accessibility, navigation and flexible search. Further, the tool will provide increased visibility of data to make more informed business decisions and reduce project risk. In addition, the tool may manage specification versions so that the most up-to-date information is always available to a project team.

As described above, the problem with prior art construction specifications is that they are typically delivered as very large text-based PDF (portable document format) documents with hundreds and sometimes more than one thousand pages and navigation is a challenge. While sectioning the specification may be helpful for navigation, manually creating hundreds of sections is very time consuming. Accordingly, embodiments of the invention provide an artificial intelligence based solution that provides an automated sectioning process.

In view of the above, one or more embodiments of the invention provide AI-powered assistance that automatically organizes large specifications into sections—thereby enabling easy navigation and information access, and supporting a wide range of building, transportation, and infrastructure specifications globally. Further, embodiments of the invention support specifications for both vertical (building) projects and all horizontal (infrastructure) projects (infrastructure projects cover a wide range of “horizontal” projects from roads, bridges, water/sewage systems/utilities, etc.). In addition, embodiments of the invention support specifications from a variety of formats and languages, both for the United States, and internationally. Supported formats include CSI (construction specification institute format), non-CSI, uniclass, CAWS (common arrangement of work sections), Natspec, DOTs (department of transportation) formats, etc. Supported project types may include any type of project including transportation (i.e., highways), buildings, airports, healthcare, water treatment facilities, bridges, etc. To better understand the invention, an architectural overview may be useful.

### Architectural Overview

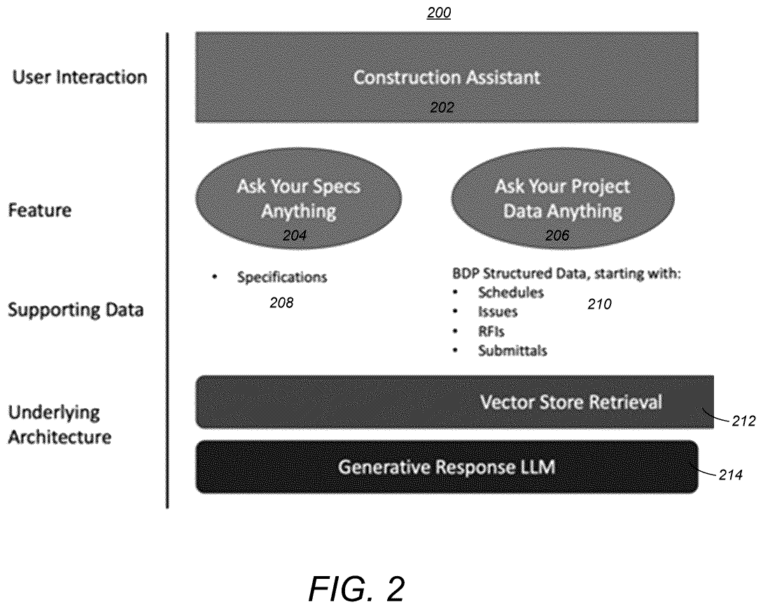

FIG. 2 illustrates an overview of the architecture for providing generative artificial intelligence (AI) information in accordance with one or more embodiments of the invention. The features of the invention are provided within a construction cloud management system 200 (e.g., the AUTODESK CONSTRUCTION CLOUD (ACC) available from the assignee of the present invention).

Within construction cloud management system 200, a “Construction Assistant” 202 provides the user interface/interaction.

The generative AI of embodiments of the invention provide features that allow a user to ask anything and retrieve data from (1) a lengthy specification (referred to as “ask your specs anything” 204) and/or (2) project management data (referred to as “ask your project data anything” 206).

In this regard, the supporting data for the Ask Your Specs Anything 204 consists of the specifications 208. The supporting data for the Ask Your Project Data Anything consists of BDP (big data protocol) structured data such as schedules, issues, RFI, submittals, etc. 210.

The underlying architecture for the features is provided via the vector store retrieval 212 and a generative response Large Advanced Language Models (LLMs) 214. In this regard, the features 204-206 leverage LLMs 214 and allow customers to ask questions and extract insights from their documents as well as project data such as schedule, issues, RFIs, submittals, etc. 210.

Further, embodiments of the invention may also include the ability to retrieve other documents besides specifications such as drawings, contracts, etc.

The Construction Assistant 202 allows customers to truly take advantage of having all their project management data on a single platform. This capability allows users to easily find information and extract insights by: (1) asking questions in natural language to their project data and documents; (2) creating ad-hoc analysis; (3) creating drafts; and (4) getting different kinds of assistance.

As described above, embodiments of the invention focus on the ask your specs anything 204 portion of the architecture and provide the ability to auto-section a specification. FIG. 3 illustrates an overview of the components and architectural workflow/data processing for auto-sectioning and utilizing a sectioned construction specification in accordance with one or more embodiments of the invention. At step 302, a query is received/obtained from an actor/user 300 (e.g., a user such as an architect, general contractor, project supervisor, etc.). As set forth herein, the query relates to a construction specification document 314 that comprises a companion contractual document to construction drawings, wherein the construction specification document is used in all phases of a construction project. At step 304, the query is translated into vectors using embedding generation models (e.g., deep learning models). More specifically, step 304 includes the generation of vector embeddings for the multiple chunks (e.g., using a deep learning model). At step 306, the relevant specification section chunks are retrieved using the query vector from step 304. At step 308, the retrieved chunk text is sent with a prompt to an LLM (large language model). The output from the LLM is then shown/provided to the user at step 310.

Area 312 illustrates the auto-sectioning workflow. The specification PDF file 314 (i.e., text from the PDF file) is provided to the auto-sectioning tool 316 which splits the text into sections. Each section's text is divided into fixed length character chunks. The text is split using a sliding window with an overlap of predefined number of characters. In other words, the text processing processes text from each section and split, for each section, the extracted text content into multiple chunks. The chunks are saved into a database/index 318 with (corresponding) section metadata and vector embeddings. In other words, the auto-sectioning 316 generates section wise chunks that are saved in database 318 along with the vector embeddings generated at 304. Within database 318, the chunks may be sorted based on pre-determined criteria.

At step 306, the top-k chunks are retrieved (e.g., from the index/database 318). More specifically, the relevant specification section chunks (from database 318) are retrieved at step 306 before being sent to the LLM for processing. The retrieved chunks are sent to an LLM along with the prompt (i.e., from the query 302) to generate the output. The output is then displayed to the user at 310 on a user interface with source section information. In other words, embodiments of the invention process the user query 302 based on the sectioned construction specification document and output results of the query to the user at 310.

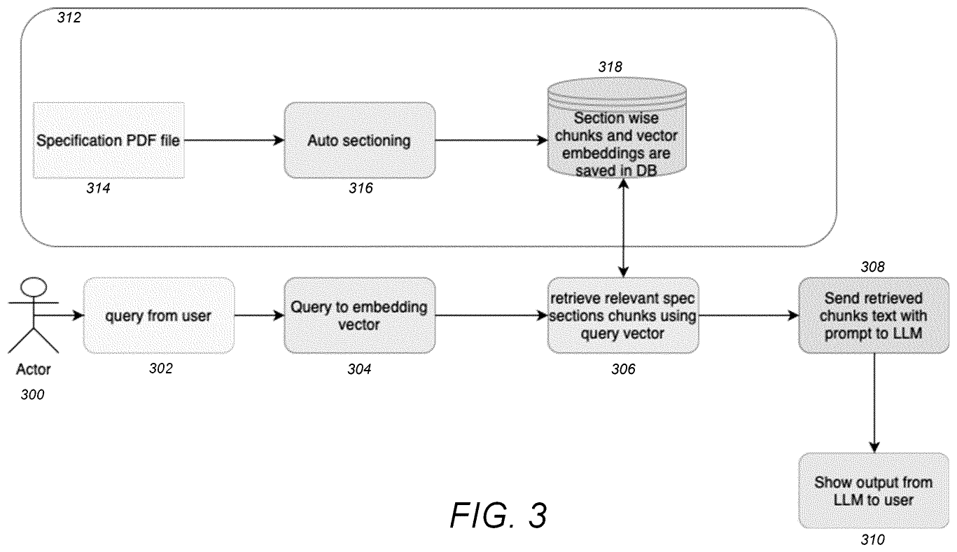

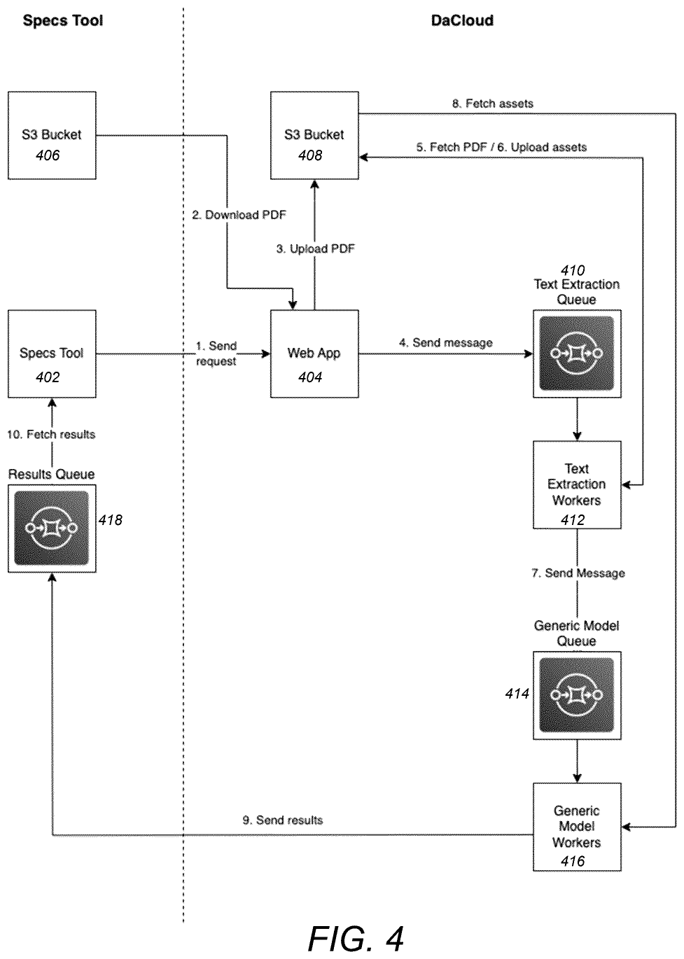

FIG. 4 illustrates further details for the integration of the auto-sectioning AI with a specification tool (i.e., that is used to query the specification) in accordance with one or more embodiments of the invention. As illustrated, the process starts with the specification tool 402 sending a request to a web application 404. The web application 404 then downloads the PDF from storage 406 (e.g., an S3 [simple storage service] bucket/container available from AMAZON™) that is maintained by the specs tool 402. The web app 404 then uploads the PDF to a cloud storage facility 408.

The web app 404 also sends a message to the text extraction queue 410 to extract the text from the PDF specification. The text extraction queue 410 assigns text extraction workers/processors 412 that fetch the PDF specification from cloud storage 408, auto-sections/extracts the text, and uploads the sectioned assets back to cloud storage 408. The workers/processors 412 then send a message to the generic model queue 414 that assigns generic model workers/processors 416 to fetch the sectioned assets from cloud storage 408 and sends the results (of the sectioned assets) to the results queue 418. The specs tool 402 then fetches/retrieves the results from results queue 418. Such processing provides the support/capability to: (1) enable internationalization (i.e., the understanding of variations of customer data across various geographies and languages); (2) utilize diverse infrastructure projects (as there are no specification standards across infrastructure projects); and (3) ensure model quality.

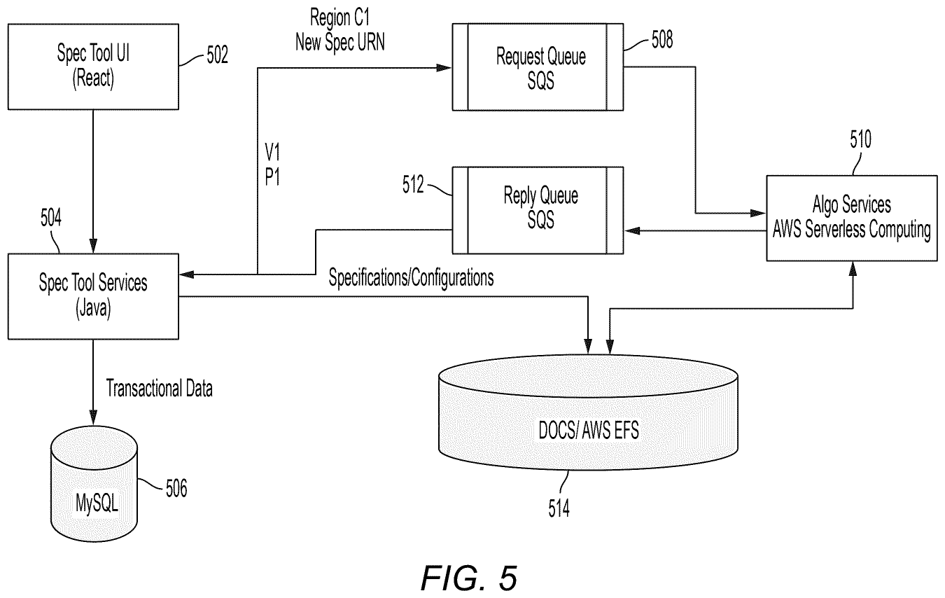

FIG. 5 illustrates an alternative view of an architecture for the automated sectioning in accordance with one or more embodiments of the invention. As illustrated, the spec tool user interface 502 (e.g., a JAVASCRIPT library such as REACT) receives user input and invokes specification tool services 504 (that may utilize JAVA services). The user input may include the region version, project, company, project type (e.g., enumerated and classified), etc. The Spec Tool services 504 may access transactional data in storage 506 (e.g., MySQL). Further, the Spec Tool 504 may utilize additional services for specific geographic areas (e.g., based o the region specified in the UI 502) such as AMAZON's SQS (Simple Queue Service) 508 to request a response from a server or a serverless cloud computing system 510 (e.g., ALGO SERVICES AWS (AMAZON WEB SERVICES serverless computing system). The response/reply queue 512 is then provided back to the Spec Tool services 504. In addition, the server/serverless computing 510 may also access storage 514 (e.g., AMAZONs ELASTIC FILE SYSTEM [EFS] or GOOGLE DOCS storage). In this regard, based on the region selection/specified in the UI 502, different formats may be utilized in/by the Spec Tool services 504 and the other system components such as the CSI format for the US/Canada, CAWS or Uniclass for UK/Ireland, and/or other formats. The different specification/configurations are fed back to the Spec Tool Services 504 and/or stored in storage 514.

FIG. 6 illustrates the specification tool workflow that utilizes the architecture of FIG. 5 in accordance with one or more embodiments of the invention. The process starts at step 602 and the user specifies the parser/template at step 605 (e.g., via the Spec Tool UI 502). Such an identification may include specifying the region, Project type, format type, etc.). In this regard, the identification at step 604 is for one of the parsers 606A-606F (e.g., US Civil Parser Java 606A, US CSI Parser Java 606B, Canada CSI Parser Java 606C, UK CAWS Parser Java 606D, UK Uniclass Parser Java 606E, and/or generic parser text/features extraction from PDF (OCR [Optical Character Recognition]/Non OCR 606F).

Different formats may require different parsers for achieving the desired result. Embodiments of the invention may be directed towards Generic format PDFs which do not adhere to the formats 606A through 606E. For such PDFs 606F, an intelligence COE (center of excellence 608) may be utilized. Within Intelligence COE 608, the service named “Generic Intelligence Service” 612 may be invoked. This service 612 is hosted on a company internal computing platform named DaCloud (610). The Generic Intelligence Service 612 accesses the PDFs 606F via a pre-signed URL as a feature file or text file. The generic service 612 uses a pre-trained ML model 614 that identifies Headings/TOC/Footers 616 from the text. Generic service 612 also identifies Speccode/Specname based on TOC/Page headings 618.

### AutoSectioning Details

Embodiments of the invention provide for autosectioning that breaks down a document (e.g., a construction specification) into smaller, logically correct segments based on metadata at a specification level. In addition, embodiments of the invention provide for an autosectioning augmented search. In an augmented, search, depending on the complexity of the question/query, novel workflows may be employed. Further, embodiments of the invention may filter away irrelevant specification sections using deep learning models. In this regard, deep learning models may be used to generate an answer from all relevant specification sections. The use of novel workflows, filtering, and deep learning greatly improves the accuracy of any search of a specification. To better understand such embodiments, a detailed description of the components and architecture that may be utilized to perform the autosectioning may be useful.

As described above, FIG. 3 illustrates the overall workflow, components, and architecture, for an autosectioning algorithm in accordance with one or more embodiments of the invention. In particular, a generic construction specification document 314 is passed to the sectioning service/autosectioning service 316. Sectioning service 316 contains three primary components that are used in sectioning generic specifications 314 into section titles:
Processor 1: Table of Content (ToC) Page Detection Module;
Processor 2: Text Extraction Module; and
Processor 3: Document Sectioning Module.

Processors 1 and 2 are applied to the document 314 in parallel. Processor 3 is applied once Processor 1 and 2 are completed. A JSON (Java Script Object Notation) containing section titles from the Specification document 314 along with the Start and End of page number relevant to the section titles (i.e., at step 306) is sent 308 to the Specification Tool (e.g., an LLM) and displayed to user at 310.

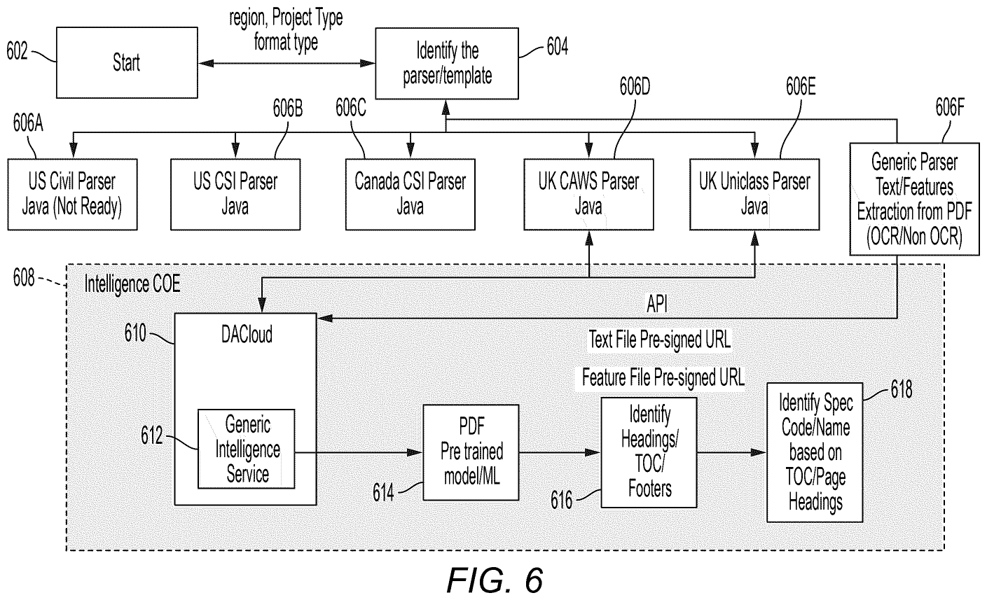

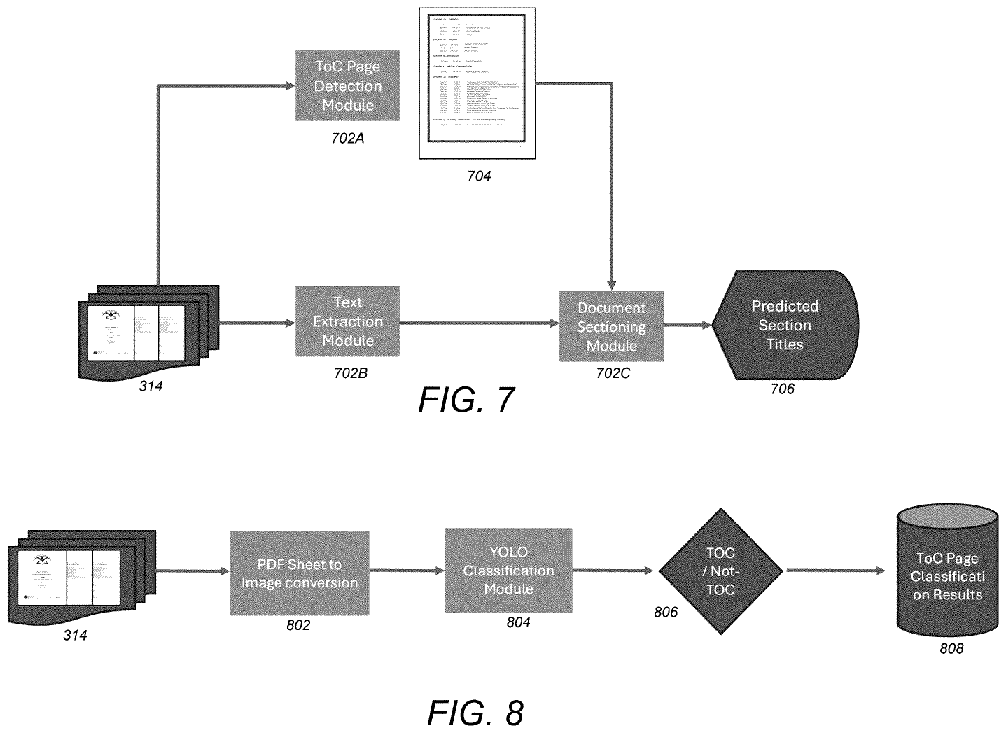

FIG. 7 illustrates details of the sectioning service that may be utilized to perform auto sectioning in accordance with one or more embodiments of the invention. As illustrated, the generic construction specification 314 is passed to the sectioning service which includes the TOC Page Detection module 702A (processor 1), the text extraction module 702B (processor 2), and the document sectioning module 702C (processor 3). The ToC page detection module 702A and text extraction module 702B are autonomously applied to the document 314 in parallel, and the document sectioning module 702C is autonomously applied once modules 702A and 702B are complete. The result from all three processors 702A-702C consists of the predicted section titles 706.

FIG. 8 illustrates further details of the ToC page detection module 702A in accordance with one or more embodiments of the invention. When a user uploads a generic specification document 314, the pages are converted into images at step 802 and processor 1 702A is applied. Processor 1 702A is a classification module 804 that uses a computer vision model that leverages machine learning (ML) to classify each page of specification document 314 as a table of contents (ToC) or not (i.e., a not ToC). In this regard, the output from the ToC page Detection module 702A consists of ToC page classification results.

As illustrated in FIG. 8, module 804 leverages YOLO (You Only Look Once) Classification architecture. The YOLO Classification Model is Trained/Fine-tuned on a set of sheets/pages sampled from a collection of generic specifications 314. Each of the pages are converted into an image from a PDF (i.e., at step 802) and is labelled/categorized as a page belonging to the category TOC or Not-TOC at 806. Any page number identified as a Table of Content is cached (i.e., in the ToC page classification results cache/database 808).

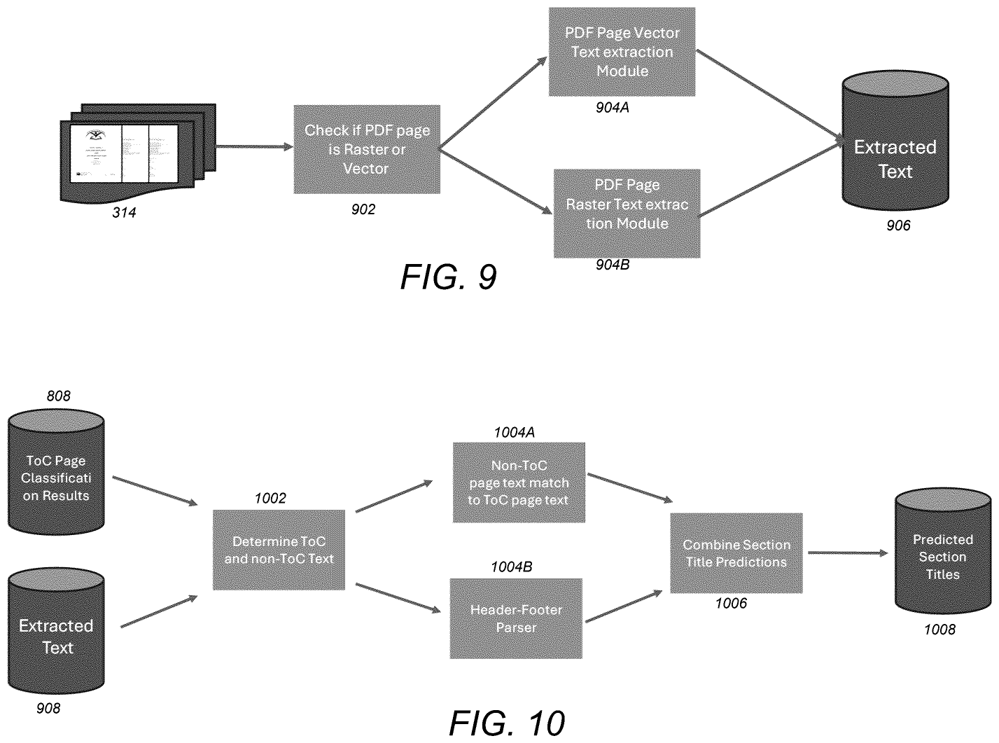

FIG. 9 illustrates further details of processor 2—the text extraction module 702B in accordance with one or more embodiments of the invention. The text extraction module 702B is a PDF processor that extracts text content (and metadata associated with the text document) from a construction specification document 314 (e.g., a PDF document format of a generic specification module 314). Essentially, all pages of the construction specification document 314 are run through processor 2 702B individually and the text and meta data associated with the text content is extracted and stored (e.g., in an extracted text storage/database 906). More specifically, at step 902, the generic specification 314 is checked to determine if a PDF page is raster or vector (i.e., if the construction specification document 314 is vector or raster based). Depending on whether a page is a vector or raster, different text extraction modules 904A (for vectors) or 904B (for raster) are utilized to extract the text that is stored (along with metadata) in database 906.

FIG. 10 illustrates the further details of processor 3—the document sectioning module 702C in accordance with one or more embodiments of the invention. Processor 3 702C carries the logic for predicting section titles. More specifically, processor 3 702C identifies section titles by determining whether text is table of content text or non table of content text at step 1002. Non-ToC page text is matched to ToC page text at 1004A and a header-footer parser is utilized to process additional headers and footers at 1004B. In other words, text is matched between ToC page text and non-ToC page text to generate first section title predictions, and a header-footer parser is utilized to generate second section title predictions. At step 1006, the section title predictions (i.e., the first and second section title predictions) are combined and output as predicted section titles that are stored in cache/database 1008. In this regard, header/footer may be separated from ToC and nonToC text (e.g., the header-footer text is separated and removed from further processing). In view of the above, the document sectioning module 702C autonomously outputs section titles based on the ToC page classification results 704 and the extracted text content (i.e., from text extraction module 702B). In addition, the document section module 702C sections the construction specification document into sections based on the section titles.

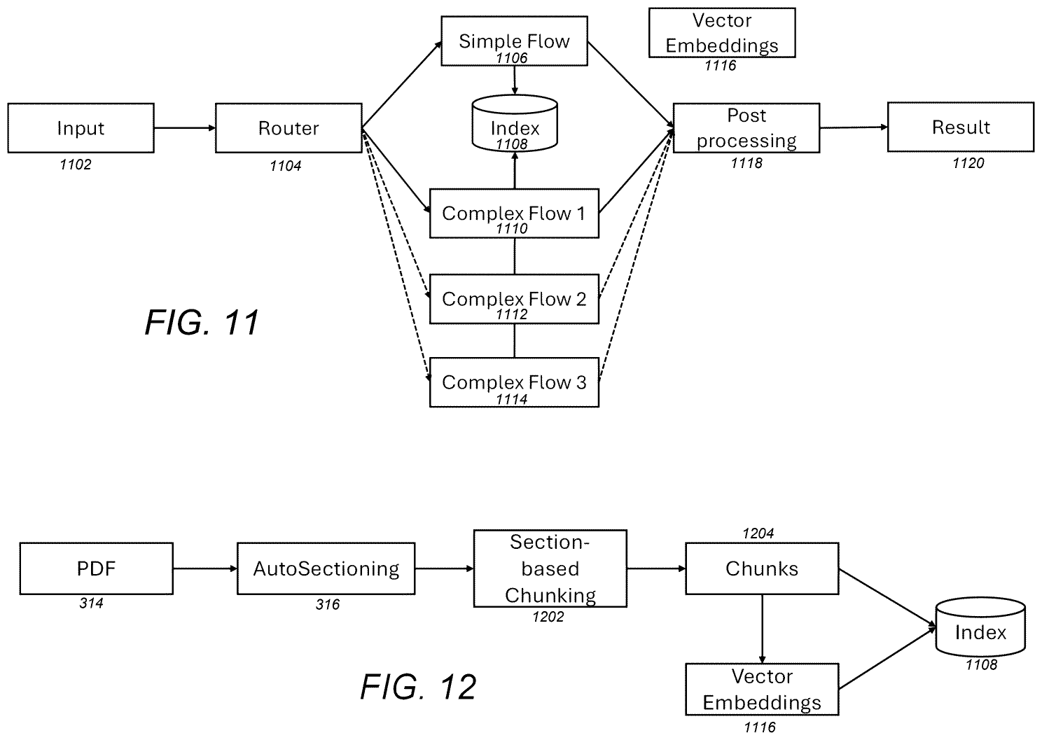

FIG. 11 illustrates the overall methodology used for extracting insights from construction specifications using generative AI. The input 1102 is a user query related to a document. The result 1120 is the response to the user query as described in the document. The router 1104 is a model that decides which flow 1106, 1110, 1112, or 1114 to use to answer the user query. The document is processed via AutoSectioning and stored in a DB. The flows 1106 and 1110-1114 consist of various algorithms to generate a response to the query. The flows 1106 and 1110-1114 use the index 1108 and vector embeddings 1116 for text retrieval. Postprocessing 1118 is applied to the response to provide the result 1120 to the user in the right format.

FIG. 12 illustrates the details for creating the index 1108 in accordance with one or more embodiments of the invention. The AutoSectioning algorithm 316 sections the PDF 314 and provides rich section level metadata and text. More specifically, the autosectioning algorithm performs text processing on the text from each section (lowercasing, remove special characters, etc.). At step 120, for each section, the text is split into appropriate chunks 1204. Vector embeddings 1116 are generated for chunks 1205 using deep learning models. Chunk text, corresponding embeddings, and metadata is stored in the index 1108. Essentially, each section is stored as a document in the index 1108. Thereafter, the index 1108 can be queried for quick retrieval.

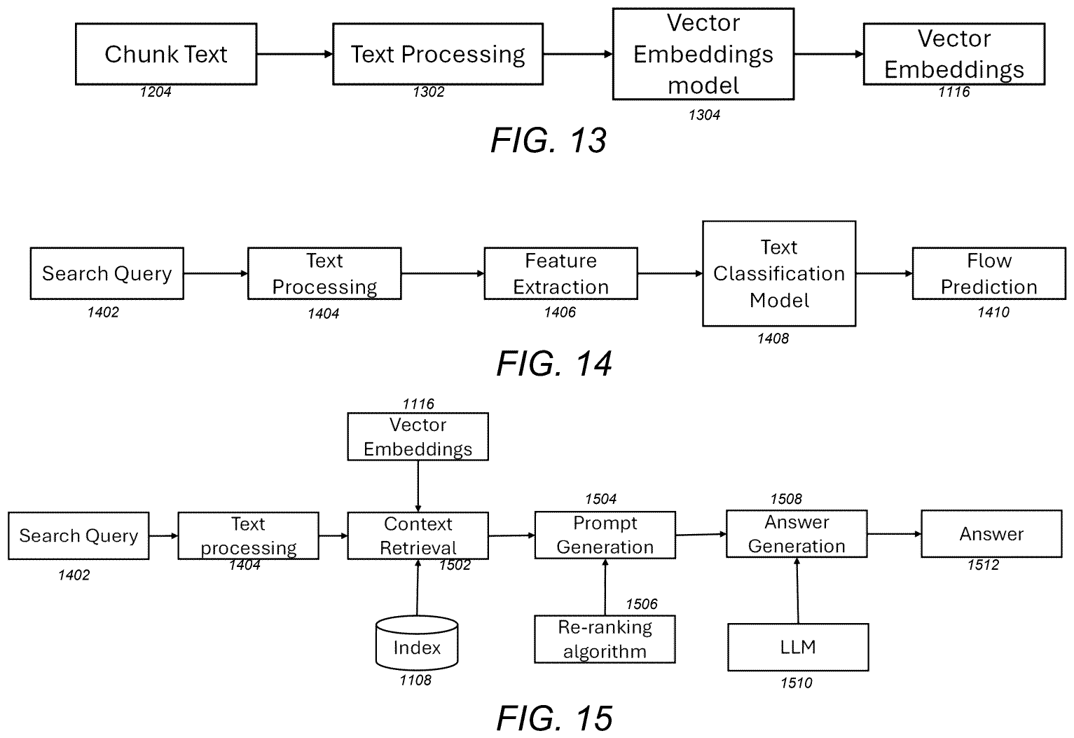

FIG. 13 illustrates the details for generating the vector embeddings 11106 in accordance with one or more embodiments of the invention. As illustrated in FIG. 12 and FIG. 13, the chunks/chunk text 1204 is processed for text processing 1302 and then passed through a vector embeddings model 1304 to generate the vector embeddings 1116. The vector embeddings model 1304 is a deep learning model that takes processed text as input and produces dense vector representations (i.e., the vector embeddings 1116) as output.

FIG. 14 illustrates the overall flow for the router/router model 1104 in accordance with one or more embodiments of the invention. The input search query/text 1402 is received and processed at 1404. After processing the text at 1404, features are extracted at 1406 for the text classification algorithm/model 1408. The model 1408 classifies the flow (simple/complex, etc.) (i.e., resulting in flow prediction 1410) for further action. The model 1408 uses ML techniques (deep learning models).

FIG. 15 illustrates the details for a simple flow 1106 in accordance with embodiments of the invention. The search query 1402 is processed at 1404. During content retrieval 1502, the processed text 1404 and corresponding vector embeddings 11116 are used to retrieve the top K (i.e., a predefined number k) best matching chunks are retrieved from the index 1108. During prompt generation 1504, the retrieved chunks are re-ranked using a re-ranking algorithm 1504 (e.g., that is based on relevancy of the matching chunks with respect to the user query) to bring the most relevant chunks to the top. In this regard, the query 1402 and finalized (i.e., re-ranked matching) chunks are put together in a prompt at 1504. An LLM 1510 is then used to generate (at 1508) a response to the user query 1402 using the prompt (i.e., resulting in answer 1512).

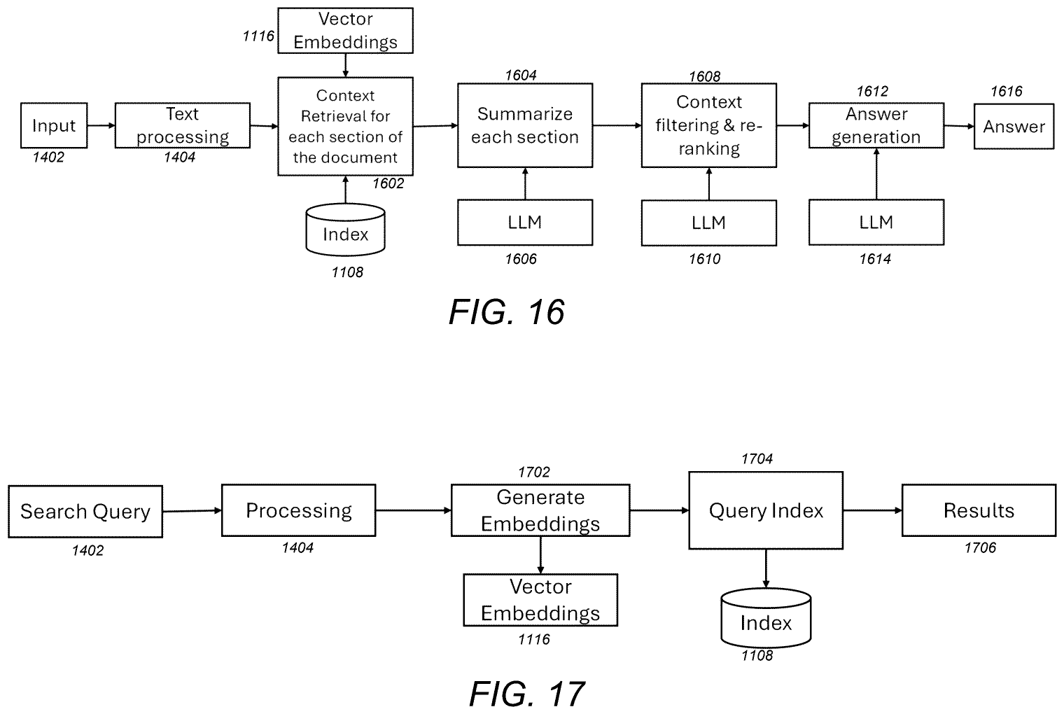

FIG. 16 illustrates the details for a complex flow 1110-1114 in accordance with one or more embodiments of the invention. As illustrated, the input query 1402 is processed at 1404. Using the processed text (from 1404) and corresponding vector embeddings 1116, the top K best matching chunks are retrieved (i.e., context retrieval) from the Index 1108 from each spec section at step 1602. The chunks retrieved are summarized at a spec section level at step 1604, based on relevance to the user input/query (e.g., via an LLM 1606). At step 1608, the summaries are then filtered and re-ranked based on relevance to the user query (e.g., using an LLM 1610). This generates final context that will be used for answer generation at 1612. The user query 1402 and final context are put together in a prompt (as part of answer generation 1612) and an LLM 1614 generates the response/answer 1616 to the user query 1402 using the prompt (e.g., which is displayed/output/provided to the user via in a user interface with source section information).

In an exemplary embodiment, a user may be searching for a manufacturer of doors and the specification may include manufacturing information for doors as well as other items. Prior art systems would search the entire specification for manufacturers and the result would include manufacturers for both doors and the other items. Embodiments of the invention separate the specification into sections with some sections relevant to doors, and others for other items (e.g., concrete). A search of embodiments of the invention based on the sectioning, would search in the door section and also search in the other item section. However, the summary would summarize the sections and when providing the answer, it could be determined from the summary that the non-door sections are not relevant and as such, would be filtered out from the query results.

FIG. 17 illustrates the details for context retrieval 1602 in accordance with one or more embodiments of the invention. The search query 1402 is processed at 1404 and vector embeddings 1116 are generated at 1702. The index 1108 is queried at step 1704 using the processed text and vector embeddings 1116. A combination of lexical and semantic search algorithms are used to retrieve the best matching results 1706 for the input text 1402.

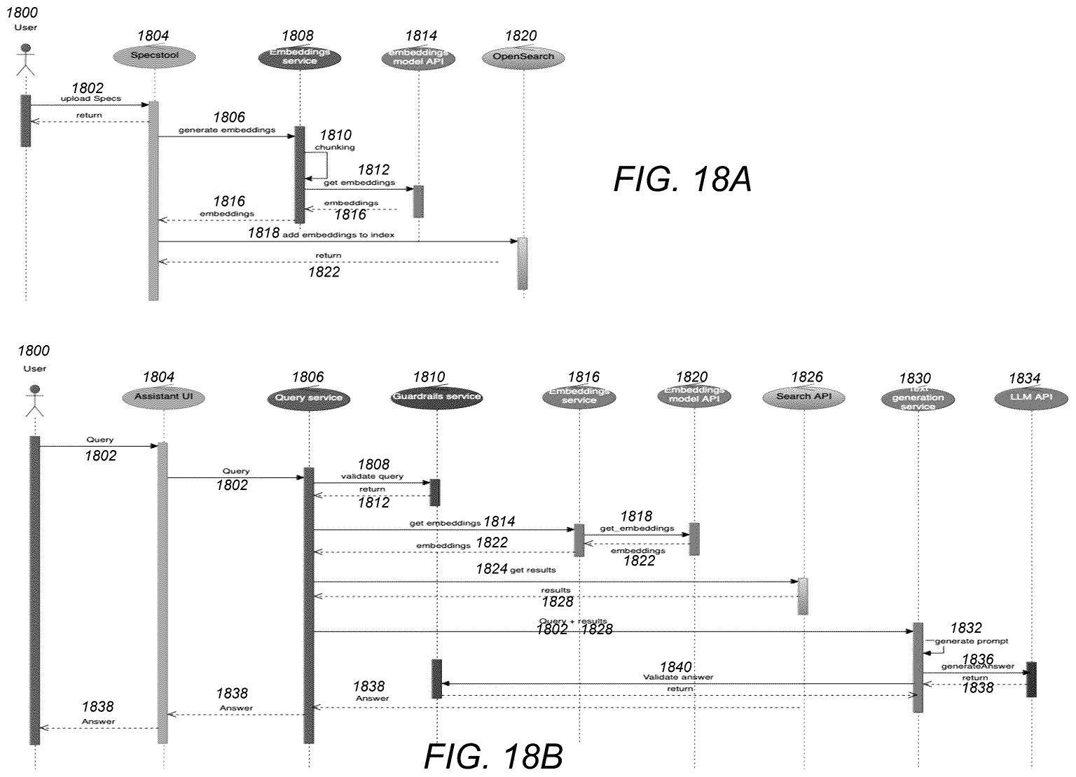

FIGS. 18A and 18B are control flow diagrams for auto-sectioning and performing a search query in accordance with one or more embodiments of the invention. In FIG. 18A (the auto-sectioning control flow), a user 1800 uploads a specification 1802 to a specification tool 1804. The specification tool 1804 passes the specification text and a request to generate embeddings 1806 to embeddings service 1808. The embeddings service 1808 performs chunking 1810 and passes the embeddings 1816 at 1812 to the embeddings model API (application programming interface) 1814. which then embeds the vectors (into embeddings 1816) and passes the embeddings 1816 back to embedding service 1808 to return to the specification tool 1804. Further, the specification tool may add (at 1818) the embeddings 1816 to an index that is provided/accessible to the open search module 1808. Search results from open search module 1820 are provided back/returned at 1822 to the specifications tool 1804.

FIG. 18B provides a control flow diagram for performing a search based on the auto-sectioned specification in accordance with one or more embodiments of the invention. The user 1800 enters the query 1802 into the assistant user interface 1804 which passes the query 1802 onto the query service 1806. The query service validates 1808 the query 1802 using guardrails service 1810 which returns the validation/validated query 1812. The query service 1806 further gets/requests 1814 the embeddings from embeddings service 1816, which in turn gets 1818 the embeddings using the embeddings model API 1820. the embeddings 1822 are then passed back via embeddings service 1816 to query service 1806.

Query service 1806 the requests search results 1824 via the search API 1826. The search results 1828 are then passed back from the search API 1826 to the query service 1806. The query service then passes the query 1802 and results 1828 onto the text generation service 1830 which generates 1832 the query prompt that is passed to the LLM API 1834. The Text generation service then generates 1836 the answer 1838 that is returned via the LLM AMP 1834. The text generation service then validates 1840 the answer via the guardrails service 1810. The answer/result 1838 is then passed back to the user 1800 via the query service 1806 and assistant UI 1804.

### Use Cases and Advantages

Embodiments of the invention may be utilized in a variety of different use cases to provide various advantages over the prior art. For example, quick insights may be extracted from voluminous contractual specification documents. In addition, the time needed to answer questions about documents is reduced. Further, anyone can use the search tool to quickly search construction specifications—no prior understanding of complex construction domain or documents is needed. Embodiments of the invention may provide the ability to identify/find a specific point mentioned in one or two continuous sentences anywhere in the document (e.g., What is the temperature requirement for pouring concrete). In addition, embodiments of the invention provide the ability to glean and summarize information that is dispersed throughout the construction/specification document.

### Hardware Environment

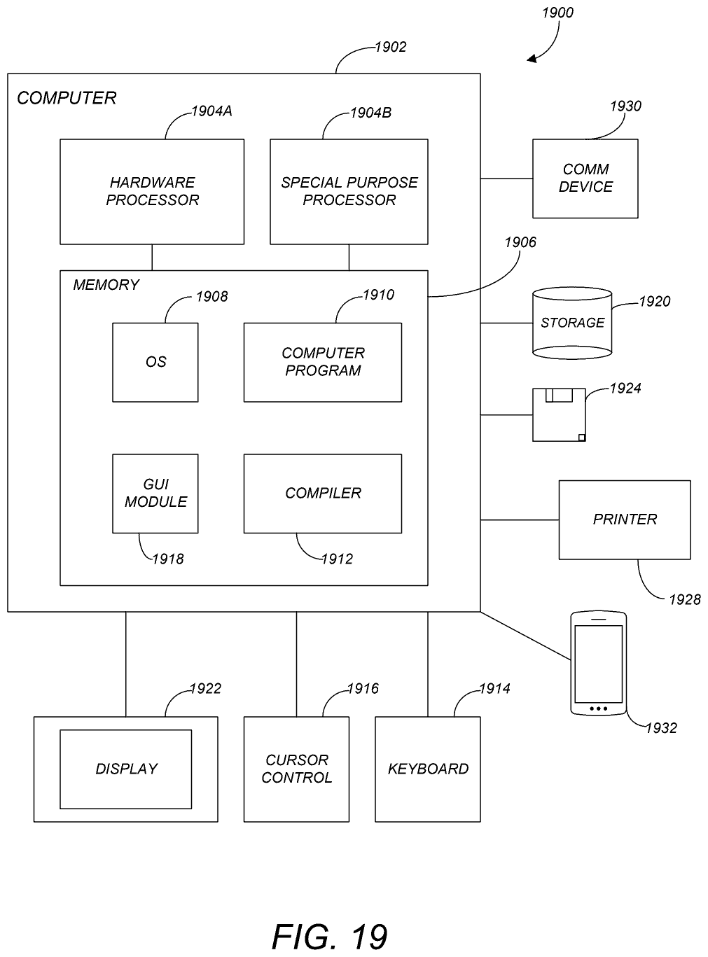

FIG. 19 is an exemplary hardware and software environment 1900 (referred to as a computer-implemented system and/or computer-implemented method) used to implement one or more embodiments of the invention. The hardware and software environment includes a computer 1902 and may include peripherals. Computer 1902 may be a user/client computer, server computer, or may be a database computer. The computer 1902 comprises a hardware processor 1904A and/or a special purpose hardware processor 1904B (hereinafter alternatively collectively referred to as processor 1904) and a memory 1906, such as random access memory (RAM). The computer 1902 may be coupled to, and/or integrated with, other devices, including input/output (I/O) devices such as a keyboard 1914, a cursor control device 1916 (e.g., a mouse, a pointing device, pen and tablet, touch screen, multi-touch device, etc.) and a printer 1928. In one or more embodiments, computer 1902 may be coupled to, or may comprise, a portable or media viewing/listening device 1932 (e.g., an MP3 player, IPOD, NOOK, portable digital video player, cellular device, personal digital assistant, etc.). In yet another embodiment, the computer 1902 may comprise a multi-touch device, mobile phone, gaming system, internet enabled television, television set top box, or other internet enabled device executing on various platforms and operating systems.

In one embodiment, the computer 1902 operates by the hardware processor 1904A performing instructions defined by the computer program 1910 (e.g., a computer-aided design [CAD] application) under control of an operating system 1908. The computer program 1910 and/or the operating system 1908 may be stored in the memory 1906 and may interface with the user and/or other devices to accept input and commands and, based on such input and commands and the instructions defined by the computer program 1910 and operating system 1908, to provide output and results.

Output/results may be presented on the display 1922 or provided to another device for presentation or further processing or action. In one embodiment, the display 1922 comprises a liquid crystal display (LCD) having a plurality of separately addressable liquid crystals. Alternatively, the display 1922 may comprise a light emitting diode (LED) display having clusters of red, green and blue diodes driven together to form full-color pixels. Each liquid crystal or pixel of the display 1922 changes to an opaque or translucent state to form a part of the image on the display in response to the data or information generated by the processor 1904 from the application of the instructions of the computer program 1910 and/or operating system 1908 to the input and commands. The image may be provided through a graphical user interface (GUI) module 1918. Although the GUI module 1918 is depicted as a separate module, the instructions performing the GUI functions can be resident or distributed in the operating system 1908, the computer program 1910, or implemented with special purpose memory and processors.

In one or more embodiments, the display 1922 is integrated with/into the computer 1902 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1902 according to the computer program 1910 instructions may be implemented in a special purpose processor 1904B. In this embodiment, some or all of the computer program 1910 instructions may be implemented via firmware instructions stored in a read only memory (ROM), a programmable read only memory (PROM) or flash memory within the special purpose processor 1904B or in memory 1906. The special purpose processor 1904B may also be hardwired through circuit design to perform some or all of the operations to implement the present invention. Further, the special purpose processor 1904B may be a hybrid processor, which includes dedicated circuitry for performing a subset of functions, and other circuits for performing more general functions such as responding to computer program 1910 instructions. In one embodiment, the special purpose processor 1904B is an application specific integrated circuit (ASIC).

The computer 1902 may also implement a compiler 1912 that allows an application or computer program 1910 written in a programming language such as C, C++, Assembly, SQL, PYTHON, PROLOG, MATLAB, RUBY, RAILS, HASKELL, or other language to be translated into processor 1904 readable code. Alternatively, the compiler 1912 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1910 accesses and manipulates data accepted from I/O devices and stored in the memory 1906 of the computer 1902 using the relationships and logic that were generated using the compiler 1912.

The computer 1902 also optionally comprises an external communication device such as a modem, satellite link, Ethernet card, or other device for accepting input from, and providing output to, other computers 1902.

In one embodiment, instructions implementing the operating system 1908, the computer program 1910, and the compiler 1912 are tangibly embodied in a non-transitory computer-readable medium, e.g., data storage device 1920, which could include one or more fixed or removable data storage devices, such as a zip drive, floppy disc drive 1924, hard drive, CD-ROM drive, tape drive, etc. Further, the operating system 1908 and the computer program 1910 are comprised of computer program 1910 instructions which, when accessed, read and executed by the computer 1902, cause the computer 1902 to perform the steps necessary to implement and/or use the present invention or to load the program of instructions into a memory 1906, thus creating a special purpose data structure causing the computer 1902 to operate as a specially programmed computer executing the method steps described herein. Computer program 1910 and/or operating instructions may also be tangibly embodied in memory 1906 and/or data communications devices 1930, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1902.

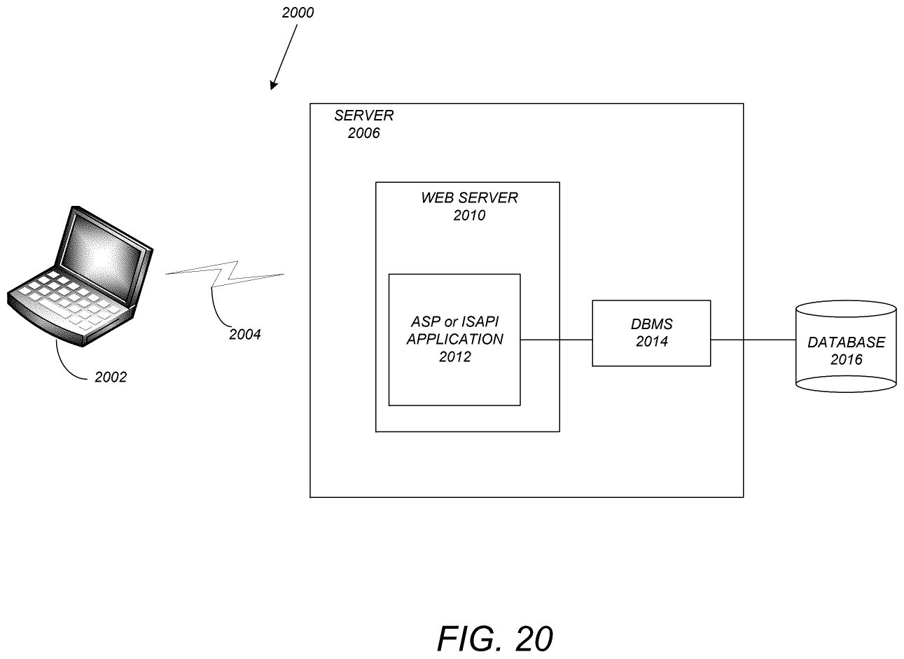

FIG. 20 schematically illustrates a typical distributed/cloud-based computer system 2000 using a network 2004 to connect client computers 2002 to server computers 2006. A typical combination of resources may include a network 2004 comprising the Internet, LANs (local area networks), WANs (wide area networks), SNA (systems network architecture) networks, or the like, clients 2002 that are personal computers or workstations (as set forth in FIG. 19), and servers 2006 that are personal computers, workstations, minicomputers, or mainframes (as set forth in FIG. 19). However, it may be noted that different networks such as a cellular network (e.g., GSM [global system for mobile communications] or otherwise), a satellite based network, or any other type of network may be used to connect clients 2002 and servers 2006 in accordance with embodiments of the invention.

A network 2004 such as the Internet connects clients 2002 to server computers 2006. Network 2004 may utilize ethernet, coaxial cable, wireless communications, radio frequency (RF), etc. to connect and provide the communication between clients 2002 and servers 2006. Further, in a cloud-based computing system, resources (e.g., storage, processors, applications, memory, infrastructure, etc.) in clients 2002 and server computers 2006 may be shared by clients 2002, server computers 2006, and users across one or more networks. Resources may be shared by multiple users and can be dynamically reallocated per demand. In this regard, cloud computing may be referred to as a model for enabling access to a shared pool of configurable computing resources.

Clients 2002 may execute a client application or web browser and communicate with server computers 2006 executing web servers 2010. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2002 may be downloaded from server computer 2006 to client computers 2002 and installed as a plug-in or ACTIVEX control of a web browser. Accordingly, clients 2002 may utilize ACTIVEX components/component object model (COM) or distributed COM (DCOM) components to provide a user interface on a display of client 2002. The web server 2010 is typically a program such as MICROSOFT'S INTERNET INFORMATION SERVER.

Web server 2010 may host an Active Server Page (ASP) or Internet Server Application Programming Interface (ISAPI) application 2012, which may be executing scripts. The scripts invoke objects that execute business logic (referred to as business objects). The business objects then manipulate data in database 2016 through a database management system (DBMS) 2014. Alternatively, database 2016 may be part of, or connected directly to, client 2002 instead of communicating/obtaining the information from database 2016 across network 2004. When a developer encapsulates the business functionality into objects, the system may be referred to as a component object model (COM) system. Accordingly, the scripts executing on web server 2010 (and/or application 2012) invoke COM objects that implement the business logic. Further, server 2006 may utilize MICROSOFT′S TRANSACTION SERVER (MTS) to access required data stored in database 2016 via an interface such as ADO (Active Data Objects), OLE DB (Object Linking and Embedding DataBase), or ODBC (Open DataBase Connectivity).

Generally, these components 2000-2016 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2002 and 2006 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2002 and 2006. Embodiments of the invention are implemented as a software/CAD application on a client 2002 or server computer 2006. Further, as described above, the client 2002 or server computer 2006 may comprise a thin client device or a portable device that has a multi-touch-based display.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for processing a construction domain query, comprising:
(a) obtaining a user query relating to a construction specification document;
(b) obtaining the construction specification document, wherein:
(i) the construction specification document comprises a companion contractual document to construction drawings;
(ii) the construction specification document is used in all phases of a construction project;
(c) a Table of Content (ToC) page detection module autonomously classifying each page of the construction specification document as a table of content (ToC) or not ToC, wherein output from the classifying comprises ToC page classification results;
(d) a text extraction module autonomously extracting text content from the construction specification document;
(e) a document sectioning module autonomously:
(i) outputting section titles based on the ToC page classification results and the extracted text content;
(ii) sectioning the construction specification document into sections based on the section titles; and
(f) processing the user query based on the sectioned construction specification document.

2. The computer-implemented method of claim 1, wherein the ToC page detection module utilizes a computer vision model that leverages machine learning to classify each page.

3. The computer-implemented method of claim 2, wherein:
the machine learning leverages a you only look once (YOLO) classification architecture; and
the YOLO classification architecture comprises a YOLO classification model that is trained on a set of pages sampled from a collection of generic specifications.

4. The computer-implemented method of claim 1, wherein the text extraction module extracts the text content by:
determining if the construction specification document is raster based or vector based;
utilizing a vector text extraction module when the construction specification document is vector based;
utilizing a raster text extraction module when the construction specification document is raster based;
storing the extracted text content and metadata in a database.

5. The computer-implemented method of claim 1, wherein the construction specification document is a portable document format (PDF) document.

6. The computer-implemented method of claim 1, wherein the text extraction module further extracts metadata associated with the text content from the construction specification document.

7. The computer-implemented method of claim 1, wherein the document sectioning module outputs the section titles by:
matching text between ToC page text and non-ToC page text to generate first section title predictions;
utilizing a header-footer parser to generate second section title predictions;
combining the first section title predictions with the second section title predictions; and
outputting the combined first section title predictions and second section title predictions as the section titles.

8. The computer-implemented method of claim 1, further comprising:
performing text processing on text from each section, wherein the text processing splits, for each section, the extracted text content into multiple chunks;
generating vector embeddings for the multiple chunks using a deep learning model; and
storing the multiple chunks, corresponding vector embeddings, and metadata in an index; and
wherein the user query is processed by querying the index.

9. The computer-implemented method of claim 8, wherein the deep learning model comprises a vector embeddings model that takes the extracted text content as input and produces a vector representation as output.

10. The computer-implemented method of claim 8, further comprising:
retrieving, using the extracted text content and corresponding vector embeddings, a top predefined number of matching chunks of the multiple chunks, from the index;
re-ranking the retrieved matching chunks using a re-ranking algorithm that is based on relevancy of the matching chunks with respect to the user query;
putting the user query and the re-ranked matching chunks together in a prompt;
generating, using a large language model (LLM) a response to the user query using the prompt.

11. The computer-implemented method of claim 8, further comprising:
retrieving, using the extracted text content and corresponding vector embeddings, a top predefined number of matching chunks of the multiple chunks, from the index;
summarizing the matching chunks at a specification section level, based on relevance to the user query;
filtering and re-ranking the summaries based on the relevance to the user query to generate a final context;
putting the user query and the final context together in a prompt;
generating, using a large language model (LLM) a response to the user query using the prompt.

12. The computer-implemented method of claim 1, further comprising:
outputting a response from the processed user query, wherein the output response is displayed in a user interface with source section information.

13. A computer-implemented system for processing a construction domain query, comprising:
(a) a computer having a memory;
(b) a processor executing on the computer;
(c) the memory storing a set of instructions, wherein the set of instructions, when executed by the processor cause the processor to perform operations comprising:
(i) obtaining a user query relating to a construction specification document;
(ii) obtaining the construction specification document, wherein:
(A) the construction specification document comprises a companion contractual document to construction drawings;
(B) the construction specification document is used in all phases of a construction project;
(iii) a Table of Content (ToC) page detection module autonomously classifying each page of the construction specification document as a table of content (ToC) or not ToC, wherein output from the classifying comprises ToC page classification results;
(iv) a text extraction module autonomously extracting text content from the construction specification document;
(v) a document sectioning module autonomously:
(A) outputting section titles based on the ToC page classification results and the extracted text content;
(B) sectioning the construction specification document into sections based on the section titles; and
(vi) processing the user query based on the sectioned construction specification document.

14. The computer-implemented system of claim 13, wherein the ToC page detection module utilizes a computer vision model that leverages machine learning to classify each page.

15. The computer-implemented system of claim 14, wherein:
the machine learning leverages a you only look once (YOLO) classification architecture; and
the YOLO classification architecture comprises a YOLO classification model that is trained on a set of pages sampled from a collection of generic specifications.

16. The computer-implemented system of claim 13, wherein the text extraction module extracts the text content by:
determining if the construction specification document is raster based or vector based;
utilizing a vector text extraction module when the construction specification document is vector based;
utilizing a raster text extraction module when the construction specification document is raster based;
storing the extracted text content and metadata in a database.

17. The computer-implemented system of claim 13, wherein the construction specification document is a portable document format (PDF) document.

18. The computer-implemented system of claim 13, wherein the text extraction module further extracts metadata associated with the text content from the construction specification document.

19. The computer-implemented system of claim 13, wherein the document sectioning module outputs the section titles by:
matching text between ToC page text and non-ToC page text to generate first section title predictions;
utilizing a header-footer parser to generate second section title predictions;
combining the first section title predictions with the second section title predictions; and
outputting the combined first section title predictions and second section title predictions as the section titles.

20. The computer-implemented system of claim 13, wherein the operations further comprise:
performing text processing on text from each section, wherein the text processing splits, for each section, the extracted text content into multiple chunks;
generating vector embeddings for the multiple chunks using a deep learning model; and
storing the multiple chunks, corresponding vector embeddings, and metadata in an index; and
wherein the user query is processed by querying the index.

21. The computer-implemented system of claim 20, wherein the deep learning model comprises a vector embeddings model that takes the extracted text content as input and produces a vector representation as output.

22. The computer-implemented system of claim 20, wherein the operations further comprise:
retrieving, using the extracted text content and corresponding vector embeddings, a top predefined number of matching chunks of the multiple chunks, from the index;
re-ranking the retrieved matching chunks using a re-ranking algorithm that is based on relevancy of the matching chunks with respect to the user query;
putting the user query and the re-ranked matching chunks together in a prompt;
generating, using a large language model (LLM) a response to the user query using the prompt.

23. The computer-implemented system of claim 20, wherein the operations further comprise:
retrieving, using the extracted text content and corresponding vector embeddings, a top predefined number of matching chunks of the multiple chunks, from the index;
summarizing the matching chunks at a specification section level, based on relevance to the user query;
filtering and re-ranking the summaries based on the relevance to the user query to generate a final context;
putting the user query and the final context together in a prompt;
generating, using a large language model (LLM) a response to the user query using the prompt.

24. The computer-implemented system of claim 13, wherein th operations further comprise:
outputting a response from the processed user query, wherein the output response is displayed in a user interface with source section information.
